(19) United States
(12) Patent Application Publication
(10) Pub. No.: US 2022/0036403 A1
(43) Pub. Date: Feb. 3, 2022

(54) SYSTEMS AND METHODS FOR PROMOTING USER ENGAGEMENT

(71) Applicant: Christopher Brinker Saxman, Henrico, VA (US)

(72) Inventor: Christopher Brinker Saxman, Henrico, VA (US)

(21) Appl. No.: 17/443,539

(22) Filed: Jul. 27, 2021

Related U.S. Application Data
(60) Provisional application No. 63/058,967, filed on Jul. 30, 2020.

(51) Int. Cl. G06Q 30/02

(52) U.S. Cl. CPC G06Q 30/0252; G06Q 30/0269; G06Q 30/0261

(57) ABSTRACT

Systems, methods, and computer-readable storage media for promoting user engagement with a software application. The system identifies users sharing a common characteristic (such as location, knowledge of a sporting event, etc.) and groups the users together. The system then prompts the users with suggestions, informing the users of specials, events, historic locations, or other relevant information regarding their shared experience. In some cases, the users can play a game, using their smart phones or other devices, where the users can be ranked against one another. These rankings can be used to determine future groups, as well as rewards or other offers.

### PRIORITY

This application claims priority to U.S. Provisional Application No. 63/058,967, filed Jul. 30, 2020, which is hereby incorporated herein by reference in its entirety.

### TECHNICAL FIELD

The present disclosure relates to methods and systems for promoting user engagement, and more specifically, to methods and systems for promoting user engagement of a plurality of users during a sports game via a software application.

### BACKGROUND

Device apps have been developed to allow users to view statistics and other aspects of sports games. Additionally, some apps allow users to connect with other users. However, these apps do not sufficiently promote users to engage with the app or with other users of the app.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a server from a user device, a characteristic about a user of the user device; determining, via the server, a group of users having the characteristic; grouping, via the server, the user into the group of users; providing, from the server to the user device based on the characteristic, a suggestion to connect to the group of users via a software application on the user device.

A system configured to perform the concepts disclosed herein can include: a processor; and a non-transitory computer-readable storage medium having instructions stored which, when executed by the processor, cause the processor to perform operations comprising: receiving, from a user device, a characteristic about a user of the user device; determining a group of users having the characteristic; grouping the user into the group of users; providing, to the user device based on the characteristic, a suggestion to connect to the group of users via a software application on the user device.

A non-transitory computer-readable storage medium configured as disclosed herein can have instructions stored which, when executed by a computing device, cause the computing device to perform operations which include: receiving, from a user device associated with a user, a location of the user device; determining that the location is within a stadium of a sporting event; identifying a group of users co-located within the stadium; grouping the user into the group of users based on: (1) the location and (2) past performance within a software application executed on the user device; transmitting, to user devices of the group of users, a suggestion regarding a food special within the stadium.

### BRIEF DESCRIPTION OF THE DRAWINGS

FIG. 1 illustrates a system, according to an embodiment;

FIG. 2 illustrates phases of a software application, according to an embodiment;

FIG. 3 illustrates an example game, according to an embodiment;

FIG. 4 illustrates a score of the example game, according to an embodiment;

FIG. 5 illustrates a ranking of the example game, according to an embodiment;

FIG. 6 illustrates a ranking of the example game, according to an embodiment; and

FIG. 7 illustrates an example computer system, according to an embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

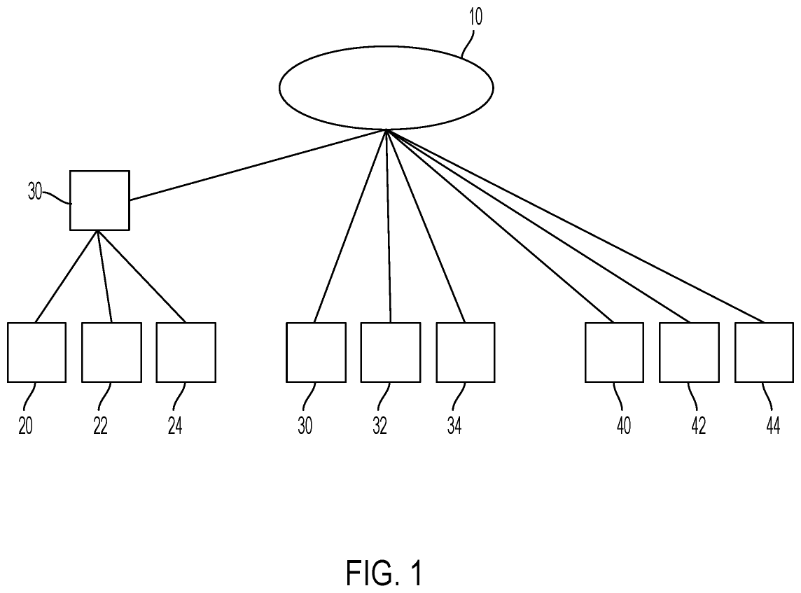

The present disclosure relates to a system and method for promoting user engagement of a plurality of users during a sports game via a software application. As illustrated in FIG. 1, the system may comprise a central server 10 communicatively connected, directly or indirectly, to a plurality of user devices 20, 22, 24, 30, 32, 24, 40, 42, 44. For example, the user devices may have a software application that communicates with the central server 10. According to an embodiment, the software application of some user devices 20, 22, 24 may be communicate with an intermediary server or access point 30 that communicates with the central server 10. According to an embodiment, the software application of other user devices 30, 32, 24, 40, 42, 44 may communicate directly with the central server 10. The various user devices may communicate with the central server 10 via an Internet connection, a data connection, or other connection known to one of ordinary skill in the art.

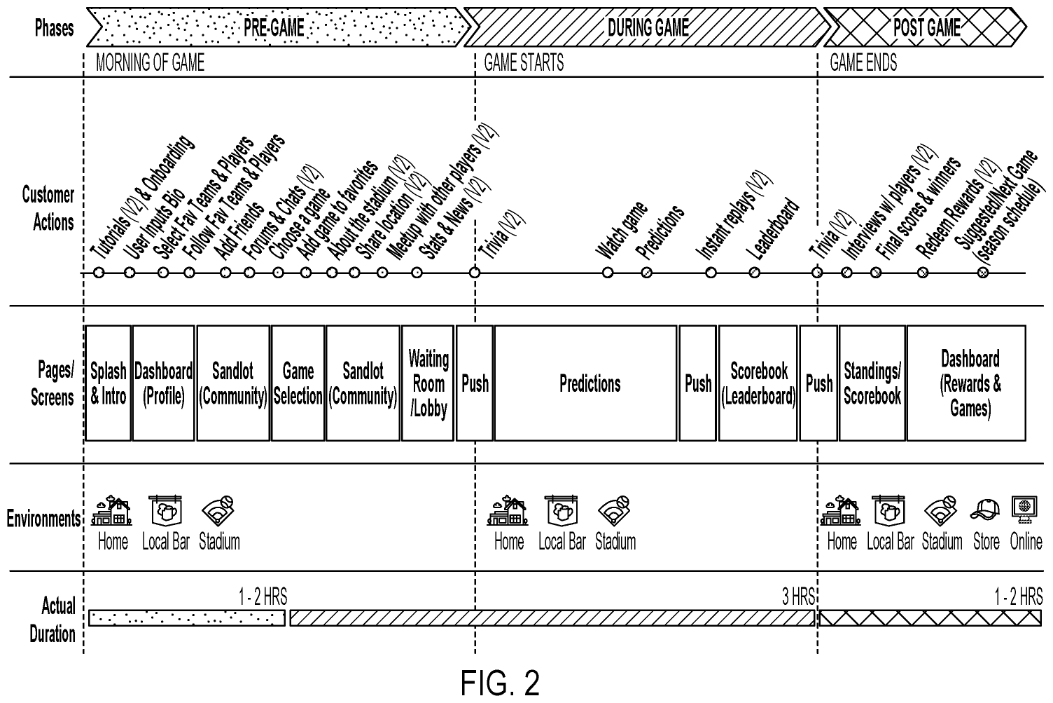

As illustrated in FIG. 2, the respective user devices may be located in a variety of different locations, such as at a home location, a business location (e.g., a bar, a restaurant, or a store), and a stadium location (e.g., the stadium that is hosting a sporting event). According to an embodiment, the software application may include a registration for the respective user that is provided to the central server 10 to identify a user with a particular user device.

The system may determine the location of the user device in order to, for example, provide different suggestions to the user. According to an embodiment, the software application may query the user at different phases of the sporting event to determine the user location. For example, the software application may receive user input that the user is located at a home location, a business location, or a stadium location. According to an embodiment, the software application may query the user device for the device location. For example, the user device may provide a geolocation based on a global positioning satellite (GPS) coordinate, based on known wifi signals, and/or based on other location discovery mechanisms for the user device. The location of the user may be provided to the central server 10 in order to determine different suggestions to provide to the user, as explained below.

The software application is configured to provide different experiences to a user over the course of a sporting event. The different phases of a sporting event may be determined by the system based on a predetermined schedule. At a predetermined amount of time prior to the beginning of a sporting event, the software application may execute a pre-game phase. When the sporting event begins, the software application may execute a game phase. Finally, when the sporting event ends, the software application may execute a post-game phase.

According to an embodiment, the users may be grouped into different groupings or sandlots based on their location, a quantified level of knowledge of the sport or sporting event, a depth of engagement with the software application, an indicated interest in a particular team, common contacts with other users, a hometown location, games watched, and/or other common characteristics that are determined by or indicated to the software application or central server 10. The groupings or sandlots are configured to allow users to engage with other users based on common characteristics on which the groupings are based. For example, users with a high level of knowledge about a sport or sporting event, such as described in more detail below, may be automatically grouped together so that those users can engage in dialogue about the sport or sporting event. In contrast, users with a lower level of knowledge about the sport or sporting event, such as described in more detail below, may be automatically grouped together so that the can discover aspects and learn more about the sport together. These groupings or sandlots may be formed, for example, irrespective of the user locations or in conjunction with the user locations, as described below.

According to an embodiment, the groupings or sandlots determined or suggested by the central server 10 or software application may change over the course of a sporting event. For example, during the pre-game phase, the central server 10 may determine that a first plurality of users are located at their respective homes, a second plurality of users are located at a restaurant, and a third plurality of users are located at the stadium of a sporting event. The central server 10 may group the first plurality of users into a first grouping or sandlot, and suggest, via the software application on the user devices, that the first plurality of users connect with each other via the software application. The central server 10 or software applications may provide one or more suggestions from a first category of suggestions to the first grouping of users that are relevant to their location (e.g., home delivery services). The central server 10 may group the second plurality of users into a second grouping or sandlot, and suggest, via the software application on the user devices, that the second plurality of users connect with each other via the software application. The central server 10 or software applications may provide one or more suggestions from a second category of suggestions to the second grouping of users that are relevant to their location (e.g., food or drink specials at a restaurant, nearby attractions, etc.). The central server 10 may group the third plurality of users into a third grouping or sandlot, and suggest, via the software application on the user devices, that the third plurality of users connect with each other via the software application. The central server 10 or software applications may provide one or more suggestions from a third category of suggestions to the third grouping of users that are relevant to their location (e.g., historical facts of the stadium, store locations in the stadium, etc.). As users move to different locations, the software application or central server 10 may determine the changed locations and re-group the users based on their changed locations in order to maintain a high level of user-to-user interaction via the software application.

The pre-game phase of the software application may make suggestions to the user in order to promote engagement by the user with the software application and with other users during the pre-game phase. For example, the software application may provide background on athletes in the upcoming sporting event, history of the teams, explanation of the rules, and/or other educational materials. The software application may also provide for engagement between users during the pre-game phase. For example, users grouped into a common grouping or sandlot, as described above, may interact with each and/or with an athlete from the upcoming sporting event. The central server 10 or the software application may determine a level of user or sandlot engagement with the software application in order to offer a reward, such as personal engagement with an athlete from the upcoming sporting event, to the user or the plurality of users in the sandlot. The level of engagement, for example, may be determined based on number of clicks or time spent on the software application.

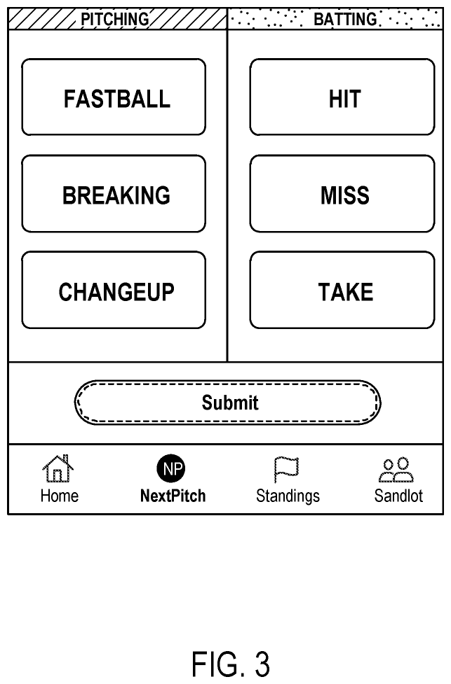

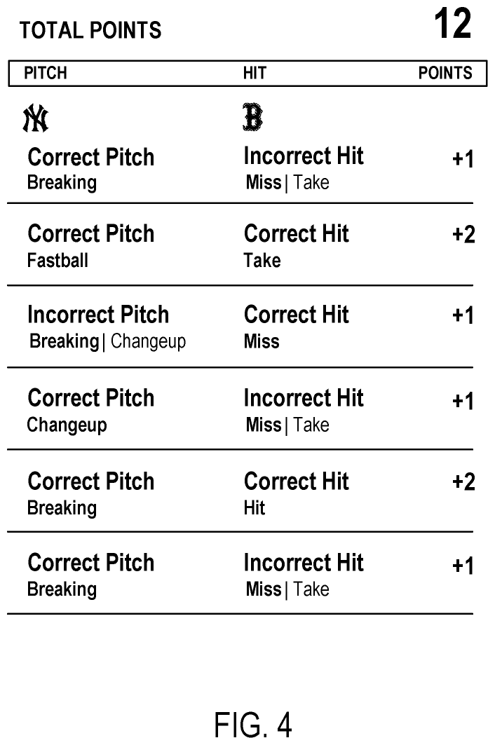

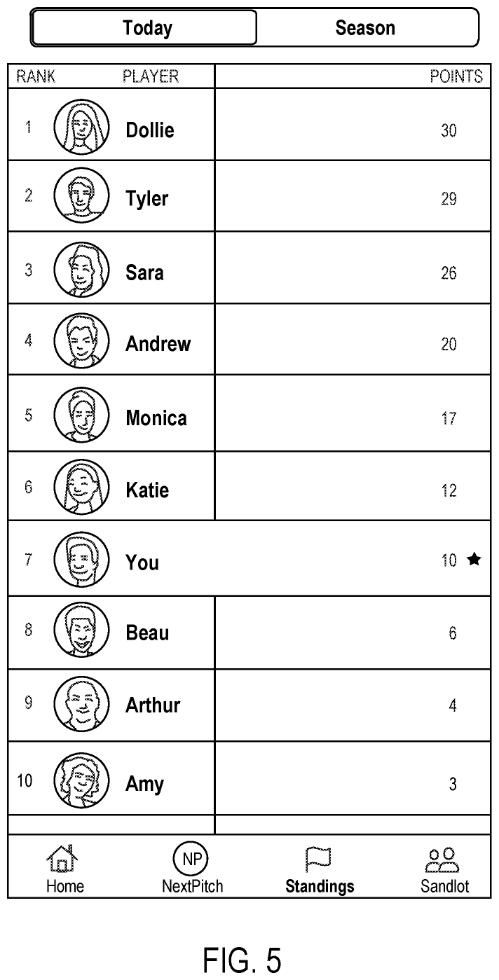

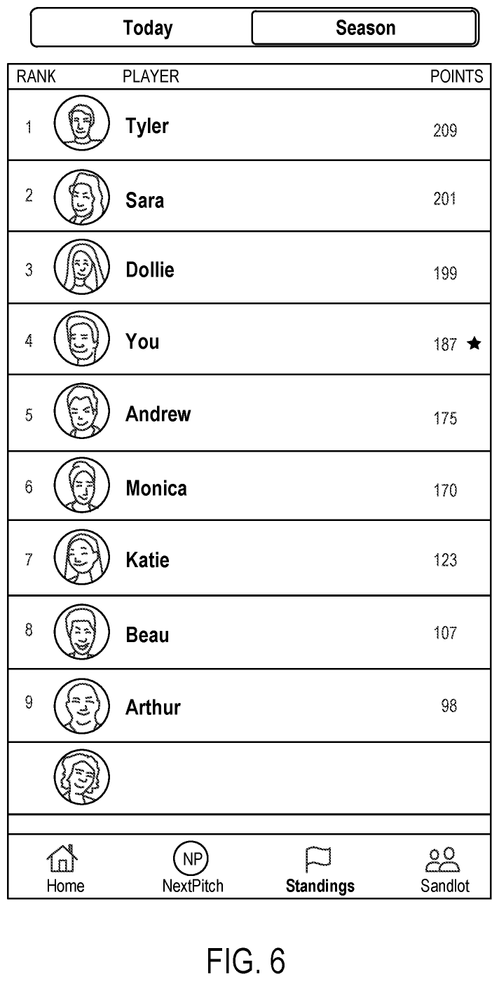

The game phase of the software application may make suggestions to the user in order to promote engagement by the user with the software application and with other users during the game phase. For example, during a baseball sporting event, the software application may display player bios and statistics to the user. According to an embodiment, the software application may provide a software game to promote user interaction with the software application. An exemplary software game for a baseball sporting event is illustrated at FIGS. 3 and 4. Prior to each pitch, the software application prompts the user to select a pitch type (e.g., fastball, breaking, changeup) and a batter outcome (e.g., hit, miss, take). After the pitch, the central server receives the actual game data of the actual pitch type and batter outcome. The software application or central server 10 compares the user selections to the actual game data, and determines a score for each pitch depending on how many selections were correct for the pitch (e.g., 0, +1, or +2). The user's total score may be determined for the sporting event and/or for a plurality of sporting events for which the user has played the software game. As illustrated at FIGS. 5 and 6, for example, the central server 10 may store the user software game scores for the sporting event or for the season, and display the user ranking to the user via the software application.

According to an embodiment, the system may determine a level of knowledge the user has about the sport or the sporting event based on the user's score in a software game, such as described above. For example, in a software game where the user is prompted to predict aspects of the sporting event, a high software game score may indicate a high level of knowledge of the sport. Similarly, a low software game score may indicate a low level of knowledge of the sport. As explained above, the user grouping or sandlots may be based on a quantified level of knowledge of the sport or sporting event, such as the software game score.

During the post-game phase, the software application may display other types of software games or trivia to the user. Like the software game described above, the software application or central server 10 may track and display the user score of the post-game software games or trivia. For example, the user score may indicate a quantified level of knowledge of the sport or sporting event.

During the post-game phase, the central server 10 or the software application may determine to offer a reward, such as personal engagement with an athlete from the sporting event, based on the level of knowledge the user or the plurality of users in the sandlot has of the game. As described above, this level of knowledge may be determined based on a software game score. For example, the reward may be offered to the user or the plurality of users in the sandlot with a high level of skill. Alternatively, the reward may be offered to the user or the plurality of users in the sandlot with a low level of skill in order to encourage these users to continue watching the sport. According to an embodiment, the reward, such as athlete interaction, may be provided through the software application.

The systems and methods described herein may be implemented on a portable user device (e.g., a smartphone or tablet), on a central server, or on both the portable user device and the central server.

An exemplary method for promoting user engagement during an event, as disclosed herein, can include: receiving, at a server from a user device, a characteristic about a user of the user device; determining, via the server, a group of users having the characteristic; grouping, via the server, the user into the group of users; providing, from the server to the user device based on the characteristic, a suggestion to connect to the group of users via a software application on the user device.

In some configurations, the characteristic can be a location category, such that the user and each user within the group of users are located within a predefined geographic boundary (such as GPS (Global Positioning System) coordinates, a neighborhood name, a stadium, a bar, a city, a state, etc.). In such configurations, the exemplary method can include: receiving, at the server from the user device after the determining of the group of users and the grouping of the user into the group of users, an updated characteristic of the user of the user device, the updated characteristic indicating the user is no longer within the predefined geographic boundary; determining, via the server, a second group of users located within a second predefined geographic boundary, the second predefined geographic boundary including the updated characteristic; grouping, via the server, the user into the second group of users; and providing, from the server to the user device based on the updated characteristic, a second suggestion to connect to the second group of users via the software application on the user device. The suggestion that is offered can be related at least one of sights or special offers within the predefined geographic boundary.

In some configurations, the exemplary method can further include: transmitting, from the server to the user device and user devices of the group of users, a prompt associated with a software game being executed on the user device and user devices; receiving, at the server from the user device and the user devices, answers from the user and the group of users with respect to the prompt; scoring, at the server, the user and the group of users based on the answers, resulting a ranking of the user and rankings of the group of users; and forming, at the server, an updated group of users based on the ranking of the user and the rankings of the group of users. In such configurations, the event can be a sporting event, and the prompt can be associated with a subsequent play in the sporting event. For example, the sporting event can be a baseball game, and the prompt of the subsequent play is regarding a type of pitch thrown and a batter outcome for a next pitch. If the sporting event were a football game, the prompt could be regarding the type of next play (run/pass) and the outcome (loss of yards, first down, pass completion, etc.). If the event is a sporting event, the system can perform the determining of the group of users and the grouping the user into the group of users occur prior to a start of the sporting event, while the the forming of the updated group of users occurs after the start of the sporting event.

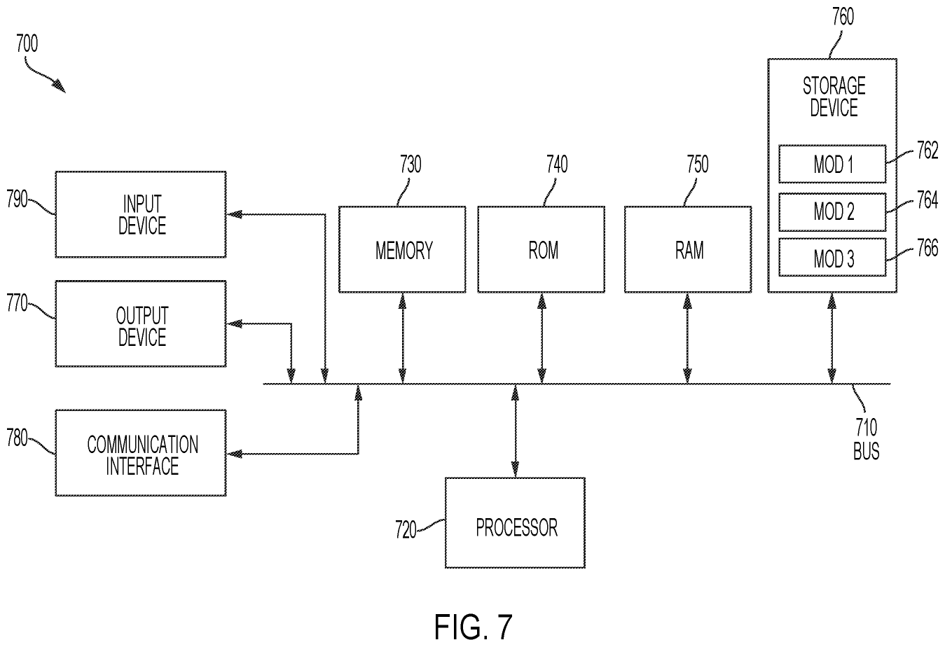

With reference to FIG. 7, an exemplary system of the controller sub-systems described above includes a general-purpose computing device 700, including a processing unit (CPU or processor) 720 and a system bus 710 that couples various system components including the system memory 730 such as read-only memory (ROM) 740 and random access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric. [0027] The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (just X, or just Y, or just Z) and multiple items (i.e., {X and Y}, {X and Z}, {Y and Z}, or {X, Y, and Z}). “At least one of” is not intended to convey a requirement that each possible item must be present. The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method for promoting user engagement during an event, the method comprising:
receiving, at a server from a user device, a characteristic about a user of the user device;
determining, via the server, a group of users having the characteristic;
grouping, via the server, the user into the group of users;
providing, from the server to the user device based on the characteristic, a suggestion to connect to the group of users via a software application on the user device.

2. The method of claim 1, wherein the characteristic is a location category, such that the user and each user within the group of users are located within a predefined geographic boundary.

3. The method of claim 2, further comprising:
receiving, at the server from the user device after the determining of the group of users and the grouping of the user into the group of users, an updated characteristic of the user of the user device, the updated characteristic indicating the user is no longer within the predefined geographic boundary;
determining, via the server, a second group of users located within a second predefined geographic boundary, the second predefined geographic boundary including the updated characteristic;
grouping, via the server, the user into the second group of users; and
providing, from the server to the user device based on the updated characteristic, a second suggestion to connect to the second group of users via the software application on the user device.

4. The method of claim 2, wherein the predefined geographic boundary comprises at least one of a stadium or a bar.

5. The method of claim 2, wherein the suggestion is related to at least one of sights or special offers within the predefined geographic boundary.

6. The method of claim 1, further comprising:
transmitting, from the server to the user device and user devices of the group of users, a prompt associated with a software game being executed on the user device and user devices;
receiving, at the server from the user device and the user devices, answers from the user and the group of users with respect to the prompt;
scoring, at the server, the user and the group of users based on the answers, resulting a ranking of the user and rankings of the group of users; and
forming, at the server, an updated group of users based on the ranking of the user and the rankings of the group of users.

7. The method of claim 6, wherein:
the event is a sporting event; and
the prompt is associated with a subsequent play in the sporting event.

8. The method of claim 7, wherein:
the sporting event is a baseball game; and
the prompt of the subsequent play is regarding a type of pitch thrown and a batter outcome for a next pitch.

9. The method of claim 6, wherein:
the event is a sporting event;
the determining of the group of users and the grouping the user into the group of users occur prior to a start of the sporting event; and
the forming of the updated group of users occurs after the start of the sporting event.

10. A system for promoting user engagement during an event, the system comprising:
a processor; and
a non-transitory computer-readable storage medium having instructions stored which, when executed by the processor, cause the processor to perform operations comprising:
receiving, from a user device, a characteristic about a user of the user device;
determining a group of users having the characteristic;
grouping the user into the group of users;
providing, to the user device based on the characteristic, a suggestion to connect to the group of users via a software application on the user device.

11. The system of claim 10, wherein the characteristic is a location category, such that the user and each user within the group of users are located within a predefined geographic boundary.

12. The system of claim 11, the non-transitory computer-readable storage medium having additional instructions stored which, when executed by the processor, cause the processor to perform operations comprising:
receiving, from the user device after the determining of the group of users and the grouping of the user into the group of users, an updated characteristic of the user of the user device, the updated characteristic indicating the user is no longer within the predefined geographic boundary;
determining a second group of users located within a second predefined geographic boundary, the second predefined geographic boundary including the updated characteristic;
grouping the user into the second group of users; and
providing, to the user device based on the updated characteristic, a second suggestion to connect to the second group of users via the software application on the user device.

13. The system of claim 11, wherein the predefined geographic boundary comprises at least one of a stadium or a bar.

14. The system of claim 11, wherein the suggestion is related to at least one of sights or special offers within the predefined geographic boundary.

15. The system of claim 10, the non-transitory computer-readable storage medium having additional instructions stored which, when executed by the processor, cause the processor to perform operations comprising:
transmitting, to the user device and user devices of the group of users, a prompt associated with a software game being executed on the user device and user devices;
receiving, from the user device and the user devices, answers from the user and the group of users with respect to the prompt;
scoring the user and the group of users based on the answers, resulting a ranking of the user and rankings of the group of users; and
forming an updated group of users based on the ranking of the user and the rankings of the group of users.

16. The system of claim 15, wherein:
the event is a sporting event; and
the prompt is associated with a subsequent play in the sporting event.

17. The system of claim 16, wherein:
the sporting event is a baseball game; and
the prompt of the subsequent play is regarding a type of pitch thrown and a batter outcome for a next pitch.

18. The system of claim 15, wherein:
the event is a sporting event;
the determining of the group of users and the grouping the user into the group of users occur prior to a start of the sporting event; and
the forming of the updated group of users occurs after the start of the sporting event.

19. A non-transitory computer-readable storage medium having instructions stored which, when executed by a processor, cause the processor to perform operations comprising:
receiving, from a user device associated with a user, a location of the user device;
determining that the location is within a stadium of a sporting event;
identifying a group of users co-located within the stadium;
grouping the user into the group of users based on: (1) the location and (2) past performance within a software application executed on the user device;
transmitting, to user devices of the group of users, a suggestion regarding a food special within the stadium.

20. The non-transitory computer-readable storage medium of claim 19, wherein the software application scores users based on predictions of a events within a sporting event made prior to performance of the events.
